(19) United States
(12) Patent Application Publication
(10) Pub. No.: US 2007/0062496 A1
(43) Pub. Date: Mar. 22, 2007

(54) System and method for operating a motor

(76) Inventors: Bradley Snower, Chicago, IL (US); Glen Snower, Chicago, IL (US)

Correspondence Address: PATENTS+TMS, P.C., 2849 W. ARMITAGE AVE., CHICAGO, IL, 60647, US

(21) Appl. No.: 11/229,734

(22) Filed: Sep. 19, 2005

(51) Int. Cl. F02G 5/00

(52) U.S. Cl. 123/549; 123/543; 123/557

(57) ABSTRACT

A system and a method operate a first motor of a vehicle which is fueled by a gellable fuel. The system and the method have a tank for storing the gellable fuel. One or more wires heat the gellable fuel to a temperature prior to injecting the gellable fuel into the first motor. One or more wires heat the gellable fuel in the tank, a fuel line, a fuel filter and an injector of the first motor. The system and the method have a second engine electrically connected to the first motor. The first motor and/or the second motor power the vehicle. One or more sensors detect and/or sense that the gellable fuel is purged from the first motor prior to disengaging the first motor. A pipe connects an exhaust pipe of the first motor to injectors for heating the gellable fuel and/or combusting unspent fuel.

### BACKGROUND OF THE INVENTION

The present invention generally relates to a system and a method for operating a motor. More specifically, the present invention relates to a system and a method for operating a motor with a non-gelling fuel and/or a gellable fuel. The system and the method may have a first tank and/or a second tank for storing the non-gelling fuel and/or the gellable fuel, respectively. Further, the system and the method may have one or more heating sources to heat the gellable fuel to an injection temperature prior to injecting the gellable fuel into the motor and/or an engine of the motor. The system and the method may have a switch to select the non-gelling fuel and/or the gellable fuel at the injection temperature for fueling the motor and/or the engine. The system and/or the method may have a purge mechanism for purging the gellable fuel from the motor and/or the engine prior to deactivating the motor. The purge mechanism may have one or more sensors to determine that the gellable fuel has been purged from the motor and/or the engine. It is generally known, for example, that a user may convert a diesel engine which may be fueled by a petro-diesel fuel to a vegetable oil engine which may be fueled by a vegetable oil. The vegetable oil engine may have a first tank for storing the vegetable oil and a second tank for storing a biodiesel fuel and/or the petro-diesel fuel. However, a composition of the vegetable oil may cause the vegetable oil to gel, to wax and/or to solidify without heating from an external heating source. A composition of the biodiesel fuel and/or a composition of the petro-diesel fuel may prevent the biodiesel fuel and/or the petro-diesel fuel from gelling, from waxing and/or from solidifying without heating from an external heating source. Traditionally, a heat exchanger connected to a radiator of the motor may be located inside the first tank for heating the vegetable oil. A coolant from the radiator may pass through the eat exchanger to transfer heat to and/or to increase a temperature of the vegetable oil in the first tank to an injection temperature, such as, for example, seventy degrees Celsius. As a result, the heat exchanger may prevent the vegetable oil from gelling, from waxing and/or from solidifying.

Additionally, the vegetable oil engine may have a fuel hose inside of a heating hose to heat the vegetable oil to the injection temperature and/or to maintain the vegetable oil at the injection temperature. The fuel hose within of the heating hose may prevent gelling, to prevent waxing and/or to prevent solidifying of the vegetable oil during injection of the vegetable oil in the vegetable oil engine. The vegetable oil may be injected into the vegetable oil engine from the first tank via the fuel hose and/or injectors of the vegetable oil engine. The coolant from the radiator may pass through the heating hose to heat the fuel hose and/or the vegetable oil within the fuel hose to the injection temperature. However, a composition of and/or a temperature of the coolant may cause the fuel hose to deteriorate and/or to rupture. The vegetable oil in the fuel hose may mix with the coolant from the heating hose and/or may be injected into the vegetable oil engine with the vegetable oil. As a result, the vegetable oil engine may be incapable of combusting vegetable oil mixed with the coolant which may cause the vegetable oil engine to stall, to deactivate and/or to be damaged.

Further, the injectors of the vegetable oil engine may not heat the vegetable oil during injection of the vegetable oil into the vegetable oil engine. The vegetable oil in the injectors may cool to a temperature below the injection temperature of the vegetable oil which may cause the vegetable oil to gel, to wax and/or to solidify in the injectors prior to injection into the vegetable oil engine. As a result, injectors may be incapable of injecting the vegetable oil into the vegetable oil engine. additionally, the vegetable oil in the injectors may not be combusted by the vegetable oil engine and may cause the vegetable oil engine to stall, to deactivate and/to be damaged by the vegetable oil in the injectors.

Still further, the vegetable oil engine may have a fuel filter for filtering the vegetable oil before the vegetable may be injected into the vegetable oil engine via the injectors. The fuel filter may heat the vegetable oil to the injection temperature and/or may maintain the vegetable oil at the injection temperature prior to injection into the vegetable oil engine with the coolant from the radiator. The coolant from the radiator may pass through the fuel filter to heat the fuel filter and/or the vegetable oil therein.

Moreover, the vegetable oil engine may have a switch for selecting the first tank or the second tank to fuel the vegetable oil engine. The user may select the biodiesel and/or the petro-diesel in the second tank with the switch to fuel the vegetable oil engine when the vegetable oil is at a temperature below the injection temperature. The heat exchanger, the heating hose, the fuel filter and/or the coolant from the radiator may heat the vegetable oil in the first tank to the injection temperature. The user may switch from the second tank to the first tank with the switch after the vegetable oil of the first tank is heated to the injection temperature. However, the vegetable oil may not be heated to the injection temperature prior to the user selecting the vegetable oil of the first tank to fuel the vegetable oil engine. The vegetable oil at a temperature below the injection temperature may be injected into the fuel line, the fuel filter and/or the vegetable oil engine. As a result, the vegetable oil at the temperature below the injection temperature may cause the vegetable oil engine to deactivate, to stall and/or to be damaged.

The vegetable oil in the fuel hose, the fuel filter, the injectors and the vegetable oil engine must be purged prior to the deactivation of the vegetable oil engine to prevent gelling, to prevent waxing and/or to prevent solidifying of the vegetable oil therein. A failure to purge the vegetable oil from the fuel hose, the fuel filter and/or the vegetable oil engine prior to deactivation of the vegetable oil engine may cause the vegetable oil engine to be inoperable and/or to be damaged. As a result, the user must switch from the first tank to the second tank to purge the vegetable oil from the fuel hose, the fuel filter and the vegetable oil engine for a duration of time, such as, for example, seven minutes prior to deactivating the vegetable oil engine. However, the user may be incapable of determining the duration of time for purging the vegetable oil from the vegetable oil engine. As a result, the user may deactivate the vegetable oil engine before the vegetable oil is purged from the fuel line, the fuel filter, the injectors and/or the vegetable oil engine which may cause the vegetable oil engine to be inoperable.

A need, therefore, exists for a system and a method for operating a motor which may be fueled by a vegetable oil, a biodiesel fuel and/or a petro-diesel vegetable oil. Additionally, a system and a method for operating a motor may provide one or more heating sources for heating the vegetable oil within of a first tank, a fuel line, a fuel filter, an injector and/or an engine of the motor. Further, a need exists for a system and a method for operating a motor which may heat the vegetable oil in the fuel line without deteriorating and/or without damaging the fuel line. Still further, a need exists for a system and a method for operating a motor which may select to fuel the engine with the vegetable oil after the vegetable oil may be heated to an injection temperature. Moreover, a need exists for a system and a method for operating a motor which may provide a pipe between an exhaust pipe of the motor and the injectors for heating the vegetable oil in the injectors. Furthermore, a need exists for a system and a method for operating a motor which may have one or more sensors to determine that the vegetable oil may have been purged from the fuel line, the fuel filter, the injector and/or the engine.

### SUMMARY OF THE INVENTION

The present invention relates to a system and a method for operating a motor which may have an engine. The system and the method for operating a motor may convert the motor from being fueled by a petro-diesel fuel and/or a biodiesel fuel to being fueled by gellable fuel, such as, for example, a vegetable oil and/or the like. Further, the system and/or the method may have one or more heating sources for heating the gellable fuel stored inside a first tank. Still further, the system and/or the method may have a power source, a fuel filter and/or a heating wire for electrically heating the gellable fuel. The system and/or the method may have a switch for selecting the first tank or a second tank which may store the gellable fuel and the biodiesel fuel and/or petro-diesel fuel, respectively. The system and/or the method may have an electric motor which may be used in conjunction with and/or may be electrically charged with the motor. Moreover, the system and/or the method may have a purge mechanism with one or more sensors for determining that the gellable fuel may be purged from the motor.

To this end, in an embodiment of the present invention, is system for operating a motor. The system has a tank having an interior wherein the interior stores a fuel wherein the fuel is gellable and combustible. Further, the system has an engine for combusting the fuel wherein the engine has an injector wherein the injector supplies the fuel to the engine. Still further, the system has a fuel line providing fluid communication between the tank to the engine. Moreover, a first wire within the injector wherein the first wire heats the fuel wherein the fuel is injected into the engine and further wherein the engine combusts the fuel.

In an embodiment, the system has a second wire within the interior of the tank wherein the second wire heats the fuel.

In an embodiment, the system has a pipe connected to the engine wherein the pipe heats the fuel.

In an embodiment, the exhaust pipe heats the first tank.

In an embodiment, the system has a power source connected to the first wire wherein the first wire heats the fuel.

In an embodiment, the system has a sensor connected to the tank.

In an embodiment, the system has a sensor located within the fuel line.

In an embodiment, the fuel is a vegetable oil.

In another embodiment of the present invention, a system for operating a motor having an exhaust pipe wherein the motor powers a vehicle is provided. The system has a tank having an interior wherein the interior stores a first fuel wherein the first fuel is a vegetable oil. Further, the system has a first engine connected to the tank via a fuel line wherein the first engine has an injector. Still further, the system has a first wire inside of the fuel line and the tank wherein the first wire heats the first fuel to a temperature wherein the first fuel is combusted by the engine and further. Moreover, the system has a second engine electrically connected to the first engine wherein the second engine is electric and further wherein the first engine or the second engine powers the vehicle. Furthermore, the system has a microprocessor connected to the first engine and the second engine wherein the microprocessor selects the first engine or the second engine to power the vehicle.

In an embodiment, the system has a second wire within the injector wherein the second wire heats the first fuel.

In an embodiment, the system has a second fuel injected into the first engine for fueling the first engine.

In an embodiment, the system has a switch connecting the microprocessor to the first engine or the second engine.

In an embodiment, the system has a battery connecting the first motor and the second motor.

In an embodiment, the system has a power source connected to he second motor.

In another embodiment of the present invention, a method for operating a motor is provided. The method has the step of providing a tank for storing a first fuel wherein the first fuel is gellable and combustible. Further, the method has the step providing an engine for combusting the first fuel wherein the engine has an injector for supplying the first fuel to the engine. Still further, the method has the steps of connecting the tank to the engine with a fuel line and heating the first fuel with a first wire to a temperature wherein the first wire is within the fuel line or the tank. Moreover, the method has the step of determining the temperature of the first fuel in the tank wherein the first fuel is injected into the engine and further wherein the first fuel is combusted in the engine.

In an embodiment, the method has the step of heating the injector with the exhaust pipe.

In an embodiment, the method has the step of detecting the first fuel within the fuel line or the injector.

In an embodiment, the method has the step of fueling the engine with a second fuel.

In an embodiment, the method has the step of heating the first fuel in the injector.

In an embodiment, the method has the step of attaching a pipe to the engine wherein the pipe heats the first tank.

It is, therefore, an advantage of the present invention to provide a system and a method for operating a motor which may electrically heat a gellable fuel via a power source and/or a heating wire.

Another advantage of the present invention is to provide a system and a method for operating a motor which may provide a heating source inside of a first tank, a fuel line, a fuel filter and/or an injection of the motor for electrically heating a gellable fuel therein.

And, another advantage of the present invention is to provide a system and a method for operating a motor which may provide an exhaust pipe which may be channeled in a sleeve through a first tank for heating a gellable fuel stored within the first tank.

Yet another advantage of the present invention is to provide a system and a method for operating a motor which may provide an engine which may be fueled by a gellable fuel, a biodiesel and/or a petro-diesel.

A further advantage of the present invention is to provide a system and a method for operating a motor which may provide a diesel engine and/or an electric engine to operate a vehicle, an aircraft, a water-craft, a transport vehicle and/or the like.

Moreover, an advantage of the present invention is to provide a system and a method for operating a motor which may electrically charge an electric motor with an engine fueled by a gellable fuel.

And, another advantage of the present invention is to provide a system and a method for operating a motor which may provide a switch to select a first tank containing gellable fuel or a second tank containing a biodiesel fuel and/or a petro-diesel fuel.

Yet another advantage of the present invention is to provide a system and a method for operating a motor which may heat a gellable fuel inside of a fuel line of the motor without deteriorating and/or without damaging the fuel line.

Another advantage of the present invention is to provide a system and a method for operating a motor which may provide purge mechanism for determining that a gellable fuel may have been purged from the motor.

Yet another advantage of the present invention is to provide a system and a method for operating a motor which may provide a laser sensor for determining that a gellable fuel may have been urged from the motor.

A still further advantage of the present invention is to provide a system and a method for operating a motor which provide a gas chromatography spectrometer sensor for determining that a gellable fuel may have been purged from the motor.

Moreover, an advantage of the present invention is to provide a system and a method for operating a motor which may heat a gellable fuel prior to injection of the gellable fuel in to an engine of the motor to prevent gelling and/or solidification of the gellable fuel within the motor.

And, another advantage of the present invention is to provide a system and a method for operating a motor which may provide a pipe connecting an exhaust pipe of an engine to an injector of the engine to provide heat and/or fuel to the injector.

Additional features and advantages of the present invention are described in, and will be apparent from, the detailed description of the presently preferred embodiments and from the drawings.

### BRIEF DESCRIPTION OF THE DRAWINGS

FIG. 1 illustrates a diagram of a system in an embodiment of the present invention.

FIG. 2 illustrates a diagram of a system in an embodiment of the present invention.

FIG. 3 is a black box diagram of a system in an embodiment of the present invention.

### DETAILED DESCRIPTION OF THE PREFERRED EMBODIMENTS

The present invention relates to a system and a method for operating a motor which may be fueled by a non-gelling fuel and/or a gellable fuel. The system and the method may have a first tank and/or a second tank for storing the gellable fuel and/or the non-gelling fuel, respectively. The system and the method may heat the gellable fuel to an injection temperature to prevent the gellable fuel from gelling, from waxing and/or from solidifying. After being heated to the injection temperature, the system and the method may select the non-gelling fuel from the first tank for fueling the motor.

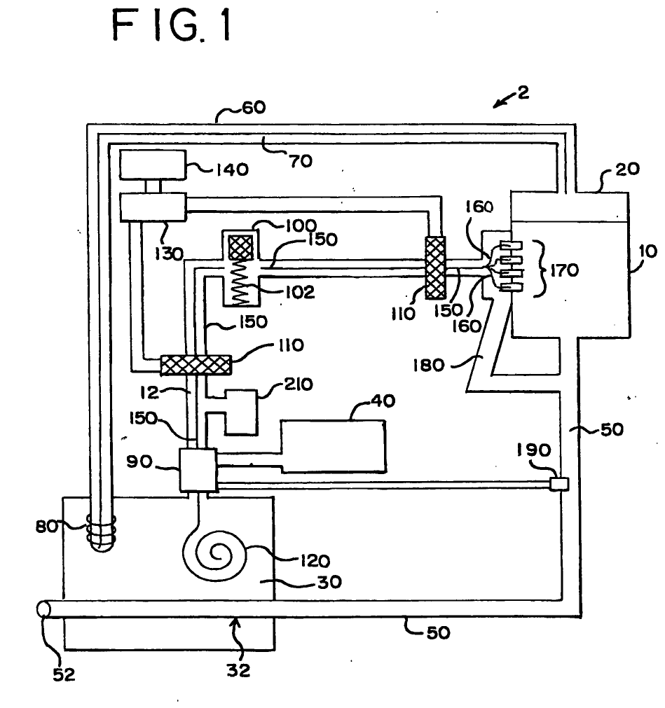

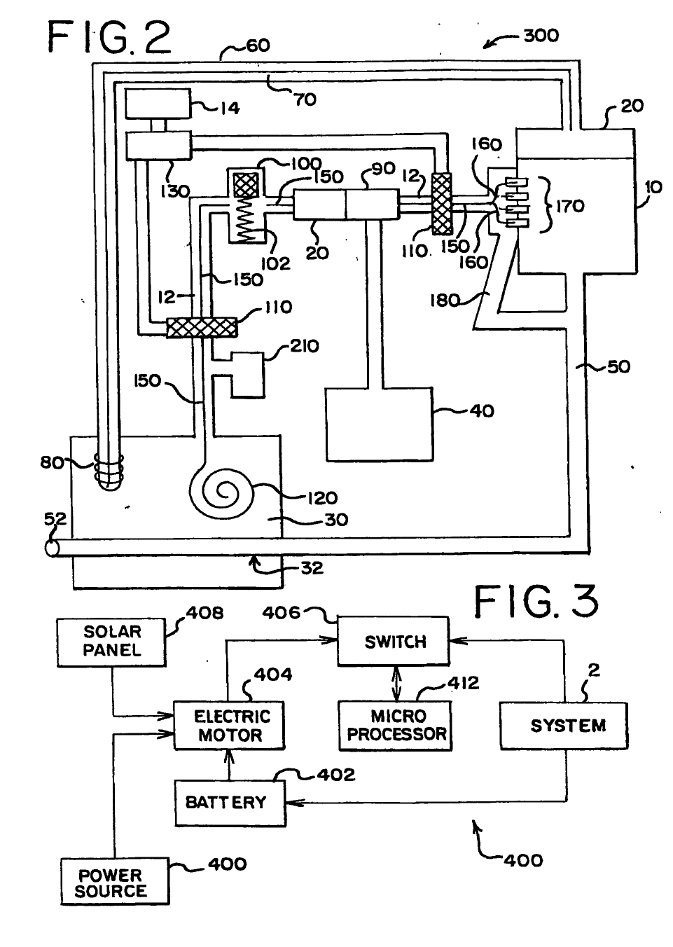

Referring now to the drawings wherein like numerals refer to like parts, FIGS. 1 and 2 illustrate systems 2, 300 which may have an engine 10, a radiator 20, a first tank 30, a second tank 40 and/or an exhaust pipe 50. The systems 2, 300 may provide mechanical power to operate a vehicle, such as, for example, an aircraft, a vehicle, a water-craft, a transport vehicle and/or the like. The radiator 20 may be attached to the engine 10 to dissipate, to release and/or to remove heat generated by the engine 10 via a coolant stored within the radiator 20. The exhaust pipe 50 may be attached to the engine 10 to dissipate, to release and/or to remove fumes and/or gases generated by the engine 10 via an opening 52 of the exhaust pipe 50. The first tank 30 and/or the second tank 40 may store a first fuel and/or a second fuel, respectively. The engine may be fueled by, may be activated with and/or may operate with the first fuel of the first tank 30 and/or the second fuel of the second tank 40. It should be understood that the vehicle may be any vehicle known to one having ordinary skill in the art.

The engine 10 may be, for example, an indirect injection engine or a direct injection engine, such as, for example, a diesel engine. The engine 10 may operate at a stroke cycle, such as, for example, a two-stroke cycle or a four-stroke cycle. The engine 10 may have a number of cylinders (not shown in the drawings), such as, for example, four cylinders, six cylinders or eight cylinders. The engine 10 may have injectors 170 to inject the first fuel and/or the second fuel into engine 10. The first fuel and/or the second fuel injected into the engine 10 may be combusted by the engine 10 to provide mechanical energy for operating, for activating and for powering the vehicle. The first tank 30 and/or the second tank 40 may be connected the injectors 170 and/or the engine 10 via a fuel line 12. The first fuel and/or the second fuel from the first tank 30 and/or the second tank 40, respectively, may be injected into the engine 10 via fuel line 12 and/or the injectors 170. The first fuel and/or the second fuel injected into the engine 10 may be combusted by the engine 10 to provide mechanical energy for operating, for activating and for powering the vehicle. The present invention should not be deemed as limited to the embodiments of a specific stroke cycle and/or a specific number of cylinders of the engine 10.

As shown in FIGS. 1 and 2, the first tank 30 may have a passage 32 extending through the first tank 30. The exhaust pipe 50 of the engine 10 may be insertable into the passage 32 of the first tank 30. The fumes and/or the gases dissipated from the engine 10 may heat the exhaust pipe 50 as the fumes and/or the gases may exit the exhaust pipe via the opening 52. The exhaust pipe 50, the fumes and/or the gases may heat the passage 32 and/or the first tank 30. As a result, a first fuel of the first tank 30 may be heated by the exhaust pipe 50 and/or the fumes and/or the gases from the engine 10. The first fuel of the first tank 30 may be heated to an injection temperature by the exhaust pipe 50 and/or the fumes and/or the gases.

The first fuel of the first tank 30 may be a gellable fuel, such as, for example, a vegetable oil, a waste vegetable oil, a mustard seed extract, a rapeseed extract, a canola oil and/or the like. The first fuel may be heated to the injection temperature prior to injecting the first fuel into the engine 10 via the fuel line 12. The first fuel at the injection temperature may be injectable into the engine 10 via the fuel line 12 and/or the injectors 170 and/or may be combustible by the engine 10. The injection temperature may be, for example, between seventy degrees Celsius (one-hundred and sixty degrees Fahrenheit) and eighty degrees Celsius (one-hundred and eighty degrees Fahrenheit). The present invention should not be deemed as limited to the embodiments of a specific gellable fuel and/or a specific injection temperature of the first fuel.

The second fuel of the second tank 40.may be non-gelling fuel, such as, for example, petro-diesel fuel, biodiesel fuel and/or the like. The biodiesel fuel may be, for example, a petroleum-based diesel fuel which may be made from a renewable resource, such as, for example, vegetable oil, animal fat and/or the like. The second fuel may be injectable into the engine 10 via the fuel line 12 and/or the injectors 170 without heating the second fuel prior to injection into the engine 10. Further, the second fuel may be combustible by the engine 10 without heating the second fuel. The present invention should not be deemed as limited to the embodiments of a specific renewable resource of the biodiesel fuel.

The systems 2, 300 and/or the engine 10 may be activated, may be engaged and/or may be started by a user (not shown in the drawings). The first fuel in the first tank 30 may be at a temperature less than the injection temperature. As a result, the systems 2, 300 may determine that the first fuel in the first tank 30 may not be at the injection temperature and/or may select the second fuel in the second tank 40 for fueling the engine 10. The systems 2, 300 and/or the engine 10 may heat the first fuel in the first tank 30 to the injection temperature. As a result, the systems 2, 300 may determine that the first fuel in the first tank 30 may be at the injection temperature and/or may select the first fuel of the first tank 30 for fueling the engine 10. The first fuel may cool from the injection temperature to a temperature less than the injection temperature. As a result, the systems 2, 300 may determine that the first fuel in the first tank 30 may not be at the injection temperature and/or may select the second fuel of the second tank 40 for fueling the engine 10.

The systems 2, 300 may have a first hose 60, a second hose 70 and/or a heat exchanger 80. The heat exchanger 80 may be located inside the first tank 30. The first hose 60 and/or the second hose 70 may be attached to the radiator 20 for connecting the heat exchanger 80 to the radiator 20. A coolant from the radiator 20 may flow in and/or flow out of the heat exchanger 80 via the first hose 60 and/or the second hose 70. The coolant and/or the heat exchanger 80 may transfer heat to and/or may heat the first fuel in the first tank 30 to preventing gelling, to prevent waxing and/or to prevent solidification of the first fuel. The heat transferred to the first fuel from the heat exchanger 80 may increase a temperature of the first fuel. As a result, the first fuel may be heated by the coolant and/or the heat exchanger 80. The heat exchanger 80 and/or coolant from the radiator 20 may heat the first fuel in the first tank 30 to the injection temperature.

As illustrated in FIGS. 1 and 2, the systems 2, 300 may have a switch 90, a fuel filter 100, a first wire 110, a coil 120, a battery 130, an external power source 140, a second wire 150 and/or a third wire 160. The battery 130 may be electrically connected to the external power source 140. The external power source 140 may electrically charge the battery 130 and/or may provide electrical power to the battery 130. The external power source 140 may be, for example, a solar cell, a fuel cell and/or the like. The battery 130 and/or the external power source 140 may be connected to the switch 90, the fuel filter 100, the first wire 110, the coil 120, the second wire 150 and/or the third wire 160. As a result, the battery 130 and/or the external power source 140 may provide electrical power to the switch 90, the fuel filter 100, the first wire 110, the coil 120, the second wire 150 and/or the third wire 160. It should be understood that the external power source may be any power source known to one having ordinary skill in the art.

The switch 90 may select the first tank 30 or the second tank 40 for fueling the engine 10. The switch 90 may operate from the electrical power which may be provided by the battery 130 and/or the external power source 140. The switch 90 may have a heat sensor (not shown in the drawings) which may determine that the first fuel may be heated to and/or maintained at the injection temperature.

When the systems 2, 300 may be activated, the first fuel may be at a temperature less than the injection temperature. As a result, the switch 90 may automatically select the second fuel of the second tank 40 for fueling the engine 10 via the fuel line 12 and/or the injectors 170. The switch 90 may automatically select the first tank 30 after the first fuel in the first tank 10 may be at the injection temperature. As a result, the first fuel may be injected into and/or may fuel the engine 10 by the switch 90, the fuel line 12 and/or the injectors 170. The first fuel at the injection temperature may automatically replace and/or may automatically be mixed with the second fuel by the switch 90 for fueling the engine 10. The switch 90 may automatically select the second tank 40 when the first fuel may not at the injection temperature and/or may be at a temperature less than the injection temperature. As a result, the second fuel may be injected into and/or may fuel the engine 10 by the switch 90 via the fuel line 12 and/or the injectors 170. The second fuel may automatically replace and/or may automatically be mixed with the first fuel by the switch for fueling the engine 10.

The user may manually select the first tank 30 or the second tank 40 with the switch 90 for fueling the engine 10. The switch 90 may indicate to the user that the first fuel may be heated to and/or may be maintained at the injection temperature. Further, the switch 90 may indicate to the user that the first fuel may be at a temperature less than the injection temperature. The user may manually select to fuel the engine 10 with the second fuel of the second tank 40. The systems 2, 300 may heat the first fuel to the injection temperature. The switch 90 may indicate to the user that the first fuel may be at the injection temperature. The user may manually select the first fuel of the first tank 30 with the switch 90 for fueling the engine 10. The first fuel may cool from the injection temperature to a temperature less than the injection temperature. The switch 90 may indicate to the user that the first fuel may not be at the injection temperature. The user may manually select the second fuel of the second tank 40 with the switch 90 for fueling the engine 10.

The first wire 110, the coil 120, the second wire 150 and/or the third wire 160 may produce, may transfer and/or may conduct heat from the electrical power provide by the battery 130 and/or the external power source 140. The first wire 110, the coil 120, the second wire 150 and/or the third wire 160 may be made from a conductive material, such as, for example, aluminum, brass, tin and/or the like. The first wire 110, the coil 120, the second wire 150 and/or the third wire 160 may be coated by a non-corrosive material, such as, for example, plastic, polyethylene, polyurethane and/or the like. The present invention should not be deemed as limited to the embodiments of a specific conductive material and/or a specific conductive material of the first wire 110, the coil 120, the second wire 150 and/or the third wire 160.

The first wire 110 may be insertable into and/or may be located within the fuel line 12 for heating the first fuel and/or the second fuel in the fuel line 12. The second wire 150 may be located within the fuel line 12 for heating the first fuel and/or the second fuel in the fuel line 12. The second wire 150 may extend from the switch 90 to the injectors 170 for heating the first fuel and/or the second fuel passing through the fuel line 12. The coil 120 may be located within the first tank 30 and may extend from the switch 90 into the first tank 30 for heating the first fuel within the first tank 30. The third wire 160 may be located within the injectors 170 for heating the first fuel and/or the second fuel in the injectors 170 prior to injecting the first fuel and/or the second fuel, respectively, into the engine 10. The third wire 160 may be, for example, frayed and/or may extend from the fuel line 12 into each of the injectors 170.

The coil 120, the heat exchanger 80 and/or the exhaust pipe 50 may heat the first fuel of the first tank 30 to the injection temperature. The heat sensor of the switch 90 may determine that the first fuel in the first tank 30 may be heated to the injection temperature. The switch 90 may select the first tank 30 for fueling the engine 10 via the fuel line 12 and/or the injectors 170. As a result, the first fuel may replace and/or may be mixed with the second fuel in the fuel line 12 via the switch 90. Alternatively, the switch 90 may be connected to a display (not shown in the drawings) which indicate to the user that the first fuel may be at the injection temperature. The user may manually select the first tank for fueling the engine 10 and/or the first fuel may replace the second fuel in the fuel line 12. The first wire 110, the-second wire 150 and/or the third wire 160 may heat the first fuel to and/or may maintain the first fuel at the injection temperature in the fuel line 12 and/or the injectors 170. As a result, the first fuel may be maintained at the injection temperature during injection from the first tank 30 into the engine 10.

The fuel line 12 may be wrapped with a heating tape (not shown in the drawings) which may be made from a material, such as, for example, silicon and/or the like. The heating tape 14 may be electrically connected to and/or may receive electrical power from the battery 130 and/or the external power source 140. As a result, the heating tape may produce, may transfer and/or may conduct heat to the fuel line 12 for heating the first fuel and/or the second fuel in the fuel line 12. The heating tape may maintain the first fuel and/or the second fuel in the fuel line 12 at the injection temperature. The third wire 160 may heat the first fuel and/or the second fuel in the injectors 170 to the injection temperature and/or may maintain the first fuel and/or the second fuel at the injection temperature in the injectors 170. As a result, the first fuel and/or the second fuel may be injected in-to the engine 10 by the injectors 170 and/or may be combusted within the engine 10. The present invention should not be deemed as limited to the embodiments of a specific material of the heating tape.

The fuel filter 100 may have a range between, for example, ten microns to forty microns. The fuel filter 100 may have a water separator (not shown in the drawings) and/or a heating wire 102 therein. Alternatively, the water separator may be attached to the fuel filter 100. The fuel filter 100 may be connected to the first tank 30 and/or the second tank 40 via the fuel line 12. The fuel filter 100 may be connected to the injectors 170 via the fuel line 12. The first fuel and/or the second fuel may be filtered by the fuel filter 100 prior to injecting the first fuel and/or the second fuel, respectively, into the engine 10 via the injectors 170. The present invention should not be deemed as limited to the embodiments of a specific range of the fuel filter 100.

As illustrated in FIG. 1, the switch 90 may be located between the fuel filter 100 and the first tank 30 and/or the second tank 40. The switch 90 may select the first tank 30 or the second tank 40 for fueling the engine 10. The first fuel and/or the second fuel may be injected from the first tank 30 and/or the second tank 40, respectively, through the fuel line 12, the fuel filter 100 and/or the injectors 170 into the engine 10. As a result, the fuel filter 100 may filter the first fuel and/or the second fuel prior to injecting the first fuel and/or the second fuel into the engine 10.

As illustrated in FIG. 2, the switch 90 may be located between the fuel filter 100 and the injectors 170 and/or the engine 10. The switch 90 may select the first tank 30 or the second tank 40 for fueling the engine 10. The first fuel may pass through the 30 fuel line 12 and/or the fuel filter 100 prior to injecting the first fuel into the engine 10 via the injectors 170. As a result, the first fuel may be filtered by the fuel filter 100 prior to injecting the first fuel into the engine 10. The second fuel of the second tank 40 may be injected into the fuel line 12 and/or the engine 10 via the injectors 170. As a result, the fuel filter 100 may not filter the second fuel prior to injecting the second fuel into the engine 10.

The heating wire 102 of the fuel filter 100 may be electrically connected to and/or may receive electrical power from the battery 130 and/or the external power source 140 via the first wire 110 and/or the second wire 150. The heating wire 102 may produce and/or may conduct heat from the electrical power provided by the battery 130 and/or the external power source 140. As a result, the heating wire 102 may heat the first fuel in the fuel filter 100 to the injection temperature and/or may maintain the first fuel at the injection temperature in the fuel filter 100 as shown in FIGS. 1 and 2.

The systems 2, 300 may have a third tank 210 and/or a trickle pipe 180 as illustrated in FIGS. 1 and 2. The third tank 210 may be connected to the fuel line 12 and/or may inject an additive into the fuel line 12. The additive may mix with the first fuel and/or the second fuel in the fuel line 12 prior to injecting the first fuel and/or the second fuel into the engine 10 via the injectors 170. Alternatively, the additive may be pre-mixed with first fuel of the first tank 30 and/or the second fuel of the second tank 40 prior to injecting the first fuel and/or the second fuel into the engine 10 via the injectors 170.

The trickle pipe 180 may connect the exhaust pipe 50 to the injectors 170 and/or the fuel line 12. The heat of the fumes and/or the gases being dissipated via the trickle pipe 180 may maintain the first fuel in the injectors 170 at the injection temperature prior to injecting the first fuel into the engine 10. Further, the heat of the fumes and/or the gases being dissipated via the trickle pipe 180 may heat the first fuel in the injectors 170 to the injection temperature prior to injecting the first fuel into the engine 10. Unspent fuel which may not have been combusted by the engine 10 may exit the engine 10 via the exhaust pipe 50. The unspent fuel may be the first fuel and/or the second fuel. The unspent fuel may flow and/or may pass to the injectors 170 via the trickle pipe 180 of the exhaust pipe 50. As a result, the unspent fuel may be injected into the engine 10 via the injectors 170 and/or combusted by the engine 10.

As the systems 2, 300 may be activated, the switch 90 may select the second fuel of the second tank 40 to fuel the engine 10. The exhaust pipe 50, the heat exchanger 80 and/or the coil 120 may heat the first fuel in the first tank 30 to the injection temperature. The switch 90 may determine and/or may indicate to the user that the first fuel of the first tank 30 may be at the injection temperature. As a result, the switch 90 may select the first fuel for fueling the engine 10 and/or for injecting the first fuel into the fuel line 12. The first wire 110, the second wire 150, the heating wire 102 of the fuel filter 100, the third wire 160 and/or the trickle pipe 180 may maintain the first fuel at the injection temperature in the fuel line 12, the fuel filter 100 and/or the injectors 170 prior to injecting the first fuel into the engine 10.

Prior to deactivating the systems 2, 300, the first fuel may be purged from the systems 2, 300 and/or may be replaced with the second fuel of the second tank 40. The switch 90 and/or the user may select the second fuel of the second tank 40 to fuel the engine 10 and/or to purge the first fuel from the systems 2, 300. The second fuel may fuel the engine 10 for a duration of time to purge the first fuel from the systems 2, 300. The present invention should not be deemed as limited to the embodiments of a specific duration of time for purging the first fuel from the systems 2, 300.

As illustrated in FIGS. 1 and 2, the systems 2, 300 may have a first sensor 190 and/or a second sensor 200, respectively, for determining that the first fuel may be purged from the systems 2, 300, respectively. The first sensor 190 may be, for example, a laser sensor which may be electrically attached to and/or in communication with the switch 90 as shown in FIG. 1. Further, the first sensor 190 may be located in the exhaust pipe 50. The first sensor may measure the fumes and/or the gases dissipating from the engine 10 via the exhaust pipe 50. The first sensor 190 may be programmed to differentiate between the fumes and the gases of the first fuel and the second fuel. The first sensor 190 may determine that the fumes and/or the gases of the first fuel may not be present in the exhaust pipe 50. The first sensor 190 may signal the switch 90 that the first fuel may be purged from the system 2. The switch 90 may indicate to the user that the first fuel may be purged from the systems 2, 300. As a result, the system 2 and/or the engine 10 may be deactivated by the switch 90 and/or the user.

As illustrated in FIG. 2, the second sensor 200 may be, for example, a gas spectrometer sensor which may be electrically connected to and/or may be in communication with the switch 90. The second sensor 200 may be located within the fuel line 12 between the fuel filter 100 and the engine 10. The second sensor 200 may detect air bubbles in the fuel line 12. After switching to the fuel filter 100, the air bubbles may be formed in and/or may pass through the fuel line 12. The second sensor 200 may detect the air bubbles and/or may signal the switch 90. As a result, the switch 90 may select the second fuel of the second tank 40 to fuel the engine 10. The air bubbles may be dissipated through the system 300, and/or the second sensor 200 may detect that the air bubbles may not be present in the fuel line 12. The second sensor 200 may signal the switch 90 that the air bubbles may not be located in the fuel line 12. As a result, the switch 90 may select the first fuel of the first tank 30 to fuel the engine 10.

FIG. 3 illustrates a system 400 in an embodiment of the present invention. The system 400 may have the system 2, a battery 402, an electric engine 404 and/or a switch 406. The system 2 may be electrically connected to the battery 402 and/or the switch 406. The user may activate the system 400 for operating and/or for powering the vehicle. As a result, the system 2 may be activated and/or may be fueled by the first fuel and/or the second fuel of the system 2.

The system 2 may produce electrical power and/or may produce electrical power which may electrically charge the battery 402. The battery 402 may store the electrical power for the electrical motor 404 to operate and/or to power the vehicle with the electrical motor 404. The electrical engine 404 may be electrically connected to a solar cell 408 and/or the power source 410. The power source 410 may be, for example, a fuel cell or the like. The solar cell 408 and/or the power source 410 may electrically charge the battery 402 and/or may provide the electrical power to the electrical motor 404 for operating the vehicle. It should be understood that the external power source may be any power source known to one having ordinary skill in the art.

The switch 406 may be electrically connected to and/or may be in communication with a microprocessor 412. The microprocessor 412 may be programmed to determine that the system 2 or the electrical motor 404 may operate the vehicle. The micro-processor 412 may determine that the electrical motor 404 may have sufficient electrical power to operate from the battery 402, the solar panel 408 and/or the power source 410. The microprocessor may signal and/or may indicate to the switch 406 that the electrical motor 404 has sufficient power to operate the vehicle. As a result, the switch 406 may select the electrical motor 404 to operate the vehicle.

The electrical motor 404 may operate the vehicle until the battery 402 and/or the electrical motor 404 may not have sufficient electrical power to operate the vehicle. The micro-processor 412 ay determine and/or may detect that the electrical motor 404 may not have the necessary electrical power to operate the vehicle. The microprocessor 412 may signal and/or may indicate to the switch 406 that the electrical motor 404 may not have the necessary electrical power to operate the vehicle. As a result, the switch 406 may select the system 2 to operate the vehicle and/or to charge the battery 402.

The systems 2, 300, 400 may be activated to operate a vehicle via mechanical power. The systems 2, 300 may have the first tank 30 and/or the second tank 40 for storing the first fuel and/or the second fuel, respectively. The systems 2, 300 may heat the first fuel to prevent gelling and/or solidifying of the first fuel prior to injecting the first fuel into the engine 10 via the injectors 170. After being heated to an injection temperature, the first fuel may be selected and/or may replace the second fuel for injecting into and/or for fueling the engine 10. The battery 130 provides electrical power to heat the first fuel in the first tank 30, the fuel line 12, the fuel filter 100 and/or the injectors 170 of the systems 2, 300. The systems 2, 300 may have a third tank 210 for storing an additive which may be injectable into the fuel line 12 and/or may be mixed with the first fuel and/or the second fuel. The systems 2, 300 may determine that the first fuel may be purged from the systems 2, 300 prior to deactivating the engine 10. The trickle pipe 180 may connect the exhaust pipe 50 of the engine 10 to the injectors 170 for heating the first fuel and/or combusting unspent fuel in the engine 10.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A system for operating a motor, the system comprising:
a tank having an interior wherein the interior stores a fuel wherein the fuel is gellable and combustible;
an engine for combusting the fuel wherein the engine has an injector wherein the injector supplies the fuel to the engine;
a fuel line providing fluid communication between the tank to the engine; and
a first wire within the injector wherein the first wire heats the fuel wherein the fuel is injected into the engine and further wherein the engine combusts the fuel.

2. The system of claim 1 further comprising:
a second wire within the interior of the tank wherein the second wire heats the fuel.

3. The system of claim 1 further comprising:
a pipe connected to the engine wherein the pipe heats the fuel.

4. The system of claim 1 wherein the exhaust pipe heats the first tank.

5. The system of claim 1 further comprising:
a power source connected to the first wire wherein the first wire heats the fuel.

6. The system of claim 1 further comprising:
a sensor connected to the tank.

7. The system of claim 1 further comprising:
a sensor located within the fuel line.

8. The system of claim 1 wherein the fuel is a vegetable oil.

9. A system for operating a motor having an exhaust pipe wherein the motor powers a vehicle, the system comprising:
a tank having an interior wherein the interior stores a first fuel wherein the first fuel is a vegetable oil;
a first engine connected to the tank via a fuel line wherein the first engine has an injector;
a first wire inside of the fuel line and the tank wherein the first wire heats the first fuel to a temperature wherein the first fuel is combusted by the engine and further;
a second engine electrically connected to the first engine wherein the second engine is electric and further wherein the first engine or the second engine powers the vehicle; and
a microprocessor connected to the first engine and the second engine wherein the microprocessor selects the first engine or the second engine to power the vehicle.

10. The system of claim 9 further comprising:
a second wire within the injector wherein the second wire heats the first fuel.

11. The system of claim 9 further comprising:
a second fuel injected into the first engine for fueling the first engine.

12. The system of claim 9 further comprising:
a switch connecting the microprocessor to the first engine or the second engine.

13. The system of claim 9 further comprising:
a battery connecting the first motor and the second motor.

14. The system of claim 9 further comprising:
a power source connected to the second motor.

15. A method for operating a motor, the method comprising the steps of:
providing a tank for storing a first fuel wherein the first fuel is gellable and combustible;
providing an engine for combusting the first fuel wherein the engine has an injector for supplying the first fuel to the engine;
connecting the tank to the engine with a fuel line;
heating the first fuel with a first wire to a temperature wherein the first wire is within the fuel line or the tank; and
determining the temperature of the first fuel in the tank wherein the first fuel is injected into the engine and further wherein the first fuel is combusted in the engine.

16. The method of claim 15 further comprising the step of:
heating the injector with the exhaust pipe.

17. The method of claim 15 further comprising the step of:
detecting the first fuel within the fuel line or the injector.

18. The method of claim 15 further comprising the step of:
fueling the engine with a second fuel.

19. The method of claim 15 further comprising the step of:
heating the first fuel in the injector.

20. The method of claim 15 further comprising the step of:
attaching a pipe to the engine wherein the pipe heats the first tank.
